(19) United States
(12) Patent Application Publication
(10) Pub. No.: US 2024/0004976 A1
(43) Pub. Date: Jan. 4, 2024

(54) SECURE PERSONAL COMMUNICATION DEVICE

(71) Applicants: Mikhail Belenkii, San Diego, CA (US); Timothy Brinkley, San Diego, CA (US)

(72) Inventors: Mikhail Belenkii, San Diego, CA (US); Timothy Brinkley, San Diego, CA (US)

(21) Appl. No.: 17/853,165

(22) Filed: Jun. 29, 2022

(51) Int. Cl. G06F 21/32; G06K 7/10; G02B 27/01

(52) U.S. Cl. CPC G06F 21/32; G06K 7/10009; G02B 27/0172; G02B 2027/0178; G02B 2027/0138; G02B 2027/014; G02B 2027/0141; G02B 2027/013

(57) ABSTRACT

A secured personal communication device (SPCD) with iris imaging and retinal scanning designed to provide sensitive or proprietary information when and where it is needed without the possibility for eavesdropping. Sensitive information is transmitted to the user only if the image of the user's iris matches a pre-recorded template of the user's iris. In preferred embodiments a waist mounted fingerprint reader and a RFID/CAC card reader provides additional assurance that transmission of sensitive information is secure. A proximity sensor and waist-mounted communication-control electronic module can also be provided to assure that there is no display of sensitive information to the wearer unless the retinal scanning and iris imaging components are located with the wearer near the eye to which sensitive information is transmitted.

### FEDERALLY SPONSORED RESEARCH

This invention was made under contract with the United States Air Force, Contract No. FA8650-19-C-6044 and the United States Government has rights in the invention.

### BACKGROUND OF THE INVENTION

### Head Mounted Displays

The most rapid transfer of information to humans is through vision. Head mounted displays are a modality of human-computer interface associated with vision. Head mounted display devices are well known. They are a small display device worn on the head sometimes as a part of a helmet. They may also be mounted on or be a part of a visor, goggles, or eyeglasses. Head mounted displays can operate in either of two modes. In “augmented reality” (AR) mode the display is see-through, and the display imagery is superimposed upon natural vision. In “virtual reality” (VR) mode, the display blocks the view entirely replacing it with displayed imagery.

### Retinal Scanning Displays

Some head mounted displays are based on a technology referred to as “virtual retinal display” or “retinal scanning display”. This is a technology that draws a raster display (like a television) directly onto the retina of the eye. The users see what appears to be a conventional display floating in space in front of them. This technology was invented by Kazuo Yoshinaka of Nippon Electric Company in 1986. Later work at the Human Interface Technology Laboratory at the University of Washington provided much smaller devices and these devices have been developed and marketed by Microvision, Inc. with headquarters in Redmond, Washington.

### Limitations of Current Head Mounted Displays

Conventional head mounted displays have several limitations. The tradeoff between spatial resolution and field-of-view limits spatial resolution. Conventional head mounted displays typically have both a limited field of view (20°-30°) and limited spatial resolution. The resolution is limited due to the finite pixel count and bandwidth restrictions.

Another limitation is that conventional head mounted displays, such as Google glass, Microsoft HoloLens, and Recon JET are not secure. These displays illuminate a large part of the eye and face and thus provide significant light leak outside of the displays. This creates an opportunity for visual eavesdropping.

### Iris Imaging

Techniques for personnel recognition utilizing iris imaging are well known. John Daugman developed the first algorithm in the 1990's and received a patent in 1994 (U.S. Pat. No. 5,291,560) covering his iris imaging invention.

### Fingerprint Recognition

Fingerprint recognition is one of the most common and well-known techniques for authentication on computerized systems. Based on comparison of a saved fingerprint pattern with the input fingerprint, this system allows one to identify humans speedily and accurately.

### RFID/CAC Card Readers

Smart radio frequency identification (RFID) card readers are well known and are utilized extensively for radio-frequency personnel identification.

### Proximity Sensors

The proximity sensors are commonly used for detecting an object's presence and distance without having any physical contact. The proximity sensor applications include detection, position, inspection, and counting in automated machines, robotics, and consumer products.

### Microprocessor

Microprocessors are available that permit the running of multiple neural networks in parallel for applications like image classification, object detection, segmentation and speed processing is commercially available. Some are in an easy-to-use platforms that require as little as 5 watts.

### Sensitive Information

Sensitive information is critical in many commercial and military enterprises. Information about covert operations, technological capabilities, proprietary property, and vulnerabilities that could be exploited by other entities must be protected. Unfortunately, this secrecy can greatly impact daily operations. Accessing confidential information may not always be possible when and where it is needed. For example, in combined operation centers people from various countries can find themselves working side-by-side with some common goals. Decisions may require access to classified information that foreign partners are not authorized to see. If the cleared individuals must go to a facility with a higher classification level in order to view critical information, timeliness of the response could be impacted. Today, a Sensitive Compartmented Information Facility (SCIF) may be needed to access classified information. But a SCIF is not always available when and where it is needed. A rush of individuals to get to a SCIF during a contingency can itself be an indicator that adversaries can exploit. On frontlines, military mechanics and maintenance crews may require access to schematics and manuals that contain confidential information, which should not fall into enemy hands. If mechanics and maintenance crews could access the information using a mobile device that did not store the information, and which is inoperable by unauthorized individuals, this problem could be solved. Commercial companies may have a need to provide timely access to secure information as well. Persons negotiating deals for a company “on the road” may require access to sensitive information. Technology to biometrically authenticate remotely located users may be a part of the future of online transactions, subscriptions, memberships, streaming music, movies, and video.

There are numerous cases in which sensitive information is inaccessible when and where it is needed. In some cases, national security may be greatly impacted. The recent COVID-19 pandemic prevented large portions of the intelligence community from accessing SCIFs thus limiting awareness of changing trends. The COVID-19 pandemic has provided an unprecedented challenge to the intelligence community,

What is needed is a mobile device that can be used to securely communicate with a Source of Sensitive Information (SSI) and provide this information when and where it is needed without the possibility of visual eavesdropping. This device should:
i) positively identify the recipient of the information who is authorized to receive it and
ii) assure that only authorized individuals can view the information.

The device should be inoperable by unauthorized individuals and free of the potential for visual eavesdropping.

### SUMMARY OF THE INVENTION

The present invention provides a secure personal communication device (SPCD) for providing secure communication between a user of the SPCD and a SSI via a retinal scan of an eye of a user during transmission of the sensitive information. In preferred embodiments the SPCD includes an iris camera system mounted on an eyeglasses frame. The camera system includes an infrared laser diode adapted to illuminate an iris of one eye of the user and a miniature camera adapted to collect iris image data from the iris of the user. The camera system may include a 850 nm long-pass filter. The SPCD may also include a communication-control module comprising a radio transceiver and a microprocessor where the microprocessor is adapted to compare collected iris images of the user of the SPCD to pre-recorded iris images to confirm or deny the correct identity of the user. The radio transceiver is preferable a secure radio transceiver adapted to transmit communications to and receive communications from the distant SSI, (1) providing to the SSI notification confirming or denying correct iris identification and (2) receiving sensitive information from the SSI in the form of radio communication. The microprocessor is adapted to convert the sensitive information, received from the distant SSI, into image information viewable by an eye of the user. The user views the information via a retinal scanning display system equipped with a set of red, green, and blue eye-safe lasers, and a MEMS mirror mounted on the eyeglasses frame. The scanning display system scans the set of laser beams from the eye-safe lasers onto the retina of an eye of the user to provide video images conveying the sensitive information. In preferred embodiments the secure communication control module is mounted on the user's waist and includes a fingerprint recognition digital devise which monitors a fingerprint of the user prior to each separate transfer of sensitive information to the user. The fingerprint recognition device may utilize an optical fingerprint scanning technology and may transmit fingerprint images to the microprocessor for verification by comparing a fingerprint image of the user with prerecorded image data contained in a pre-recorded fingerprint database so as to provide additional certainty to the SSI that the identity of the user is who he or she should be. Preferred embodiments may also include a RFID/CAC card reader which compares a RFID/CAC card possessed by the user with prerecorded information contained in a database so as to provide additional certainty to the SSI that the identity of the user is who he should be. Also, preferred embodiments may include a proximity sensor mounted on the eyeglasses frame and programmed to prevent in less than 0.1 second communication from the distant SSI to the SPCD if the iris camera is more than 3 centimeters from the user's eye.

In preferred embodiments the retinal scanning display is a modified version of an Augmented Reality (AR) Retissa display having a combiner mirror to direct the diode laser beam to the user's retina and an opaque blocker on the eyeglasses to block first pass transmissions to minimize the probably of, or prevent, any eavesdropping. In other preferred embodiments, the retinal scanning display may be a modified version of a Retissa display with a notch filter applied to the combiner mirror to block first pass transmission through the combiner mirror to minimize probability of or prevent visual eavesdropping. The iris camera may be a miniature Omnivision OVM6211 camera and the proximity sensor may be a VL6180X proximity sensor from STMicroelectronics. The secure communication transceiver could be a GoSilent Cube from Attila Security. The microprocessor could be a Jetson Nano embedded processor, and the fingerprint reader could be a U.are.U 4500 fingerprint reader could be supplied by DigitalPersona. A good card reader is MicroSD Card Reader from Adfruit Industries. Enrollment data base with iris and fingerprint templets and RFID/CAC card numbers of the authorized and enrolled individuals are preferably stored at the distant SSI and transmitted to SPCD after a headshake between secure communication transceiver of the SPCD and secure communication transceiver of the SSI to prevent a loss of this information if the SPCD is lost, or stolen.

In preferred embodiments the system continuously performs iris and RFID/CAC card identification checks and proximity sensor checks in real time. The iris imager and the RFID/CAC card identification checks can be performed at the rate of 0.5 Hz. The proximity sensor is checked at the rate of 10 Hz. The fingerprint identity is preferably checked at least once at the start of an operation mode activated on power-up. In operation mode, once a positive identification of the RFID/CAC card and, fingerprint, and iris images and obtained, and the proximity sensor is valid, an augmented reality image is displayed directly on the retina of an eye of the user which may be the same eye of the authorized individual that is used for identification or it could be the other eye. In the case of unauthorized individuals, the device remains inoperable. Preferably the device does not store any sensitive information.

Important applications of the invention include multi-domain command and control (MDCC) centers and international operation centers where multinationals and persons with diverse levels of clearance work side by side with common goal. Using the SPCD, authorized persons will be able to access situation relevant information without moving to a secure location. Military mechanics and maintenance personnel can use the SPCD to securely obtain sensitive information (schematics, technical drawings, repair, and service manuals) both at military bases, or near the frontline in combat situations using the SPCD. Also, commercial organizations can use the SPCD to protect personal or confidential information in many non-secure public settings.

### BRIEF DESCRIPTION OF THE DRAWINGS

FIG. 1 presents a block diagram illustrating use of the SPCD system in accordance with an exemplary embodiment of the present disclosure.

FIG. 2 is a schematic of Rettissa retinal scanner with combiner mirror illustrating the fist-pass light transmission through the combiner.

FIG. 3 is a picture of an assembled communication-control module enclosure. Both head and waist modules can be carried out in a commercial waist pack.

FIG. 4 are iris images recorded using the iris camera integrated into the Head Module; red and green circles show pupil and iris boundaries detected by the VeriEye iris recognition software.

FIG. 5 shows fingerprint images recorded using DigitalPersonal U.are.U 4500 fingerprint scanner from HID Global. Red marks show minutia determined by VeriFinger algorithm from Neuro Technology Inc.

FIG. 6 shows software flow in fingerprint enrollment mode.

FIG. 7 shows software flow in iris enrollment mode.

FIG. 8 shows software flow in operating mode.

### DETAILED DESCRIPTION OF PREFERRED EMBODIMENTS

Preferred embodiments of the present invention include a head module and waist module connected by a fiber optic and high-definition multimedia interface (HDMI) cables. The head module comprises the eyeglasses frame and a miniature iris camera system mounted on the eyeglasses frame and adapted to collect image data from one iris of the user. The camera system may include an 850 nm long-pass filter and a near infrared (NIR) light emitting diode (LED) adapted to illuminate the iris of one eye of a user of the SPCD. Preferred embodiments also include a retinal scanner, including eye-safe red, green, and blue lasers, fiber optic cable, and MEMS mirror mounted on the eyeglasses frame and adapted to scan laser beams from the eye-safe lasers on the retina of the one eye of the user to produce video images on the retina. A retinal scanner controller located in a communication-control module is connected to the retinal display mounted on the eyeglasses frame of the head module by a fiber optic cable, and adapted to control scans the red, green and blue lasers on the retina of the eye of the user.

The preferred embodiments of the SPCD may also include a proximity sensor mounted on the eyeglasses frame and pointed at the user's face to confirm that the eyeglasses are properly located during transfer of the sensitive information. A reason for including a proximity sensor in the head module is that a sampling rate of the proximity sensor (10 Hz) is much higher than the sampling rate of the iris camera and iris ID software (0.5 Hz). This permits a shut off of the secure display quickly to prevent a loss, or compromise, of a sensitive information.

A proximity sensor continuously confirms the distance between the head module and user's eye. When the head module is removed from the authorized person's face, the proximity sensor shuts off the secure display in less than 0.1 second and erases stored content in a video buffer in the retinal scanner. So, no sensitive information is stored in the video buffer for longer than 0.1 second, except in the course of the information being transmitted to the user via his or her retina. The retinal scanner controller will prevent any transfer and storage of information until RFID/CAC card, fingerprint, and iris of the user are positively identified and proximity sensor readings confirm that the retinal scanner is positioned on the user's head.

The communication-control module comprises a secure communication transceiver adapted to receive information from at least one distant SSI in the form of displayed images scanned on the retina of one eye of the wearer, and to transmit communications to the SSI results confirming or not confirming identification of the user. The communication-control module also includes fingerprint and RFID/CAC readers, retinal scanning display controller, re-chargeable batteries, and the microprocessor which may be programed to compare in addition to the iris images:
(1) fingerprint images, and
(2) RFID/CAC card information,
   with prerecorded data.

The microprocessor may convert iris image data and fingerprint image data collected by the iris camera and fingerprint reader into sets of digital information permitting a comparison of the collected iris and fingerprint information with the pre-recorded information (templets) using iris and fingerprint recognition algorithms and to produce a recognition or non-recognition results. In addition, the microprocessor compares the RFID/CAC card number from the card reader with the card number stored in a database.

The microprocessor may also control the retinal scanning display controller to permit the retinal display to produce the video images on the retina based on the information received via secure communication link from the distance SSI.

The SPDC supports secure operation and is designed to eliminate any possibility of visual eavesdropping. During operation on an authorized individual, there is no detectable light leakage from the SPDC display. The SPDC creates an image directly on the retina and does not illuminate any other parts of the eye and face. First pass transmission through combiner of a retinal scanning display is preferably eliminated by placing a small opaque blocker to the eyeglasses.

Preferred embodiments of the SPCD provides the following benefits, it:
i) eliminates the possibility of visual eavesdropping by preventing detectable light leakage outside of the display
ii) integrates 3-level biometric identification and retinal scanning systems into a single battery powered wearable device
iii) continuously scans iris and RFID card for user authentication
iv) positively identifies authorized individuals by collecting fingerprints and iris images of the eye to which sensitive information is displayed, as well as reading RFID/CAC card number
v) a proximity sensor shuts down the SPCD immediately when it is removed from an authorized person's face; and
vi) sensitive information is only visible when it reaches the retina of an authorized individual
vii) increases the agility and security of controlled distribution of sensitive, confidential, and proprietary information.
viii) The SPCD technology could reduce the number of secure facilities (Sensitive Compartmented Information Facilities (SCIFs) which can be expensive to construct, accredit, and maintain. The cost to build a 200 sq.ft SCIF is $200,000 and this capability could eliminate the need for an estimated 100 SCIFs worldwide for a total of $20 M savings not including annual maintenance costs.

The SPCD also increases the agility and security of controlled distribution of sensitive, confidential, and proprietary information. The high-speed targeted distribution of sensitive information will allow operators to make more rapidly more informed decisions. It can be used by personnel in operations centers, especially those that include multinationals like the Combined Space Operations Center (CSpOC) at Vandenberg AFB, CA. Users may be able to access situationally relevant information without moving to a separate vault. If personnel can continue to work together while securely accessing important information at multiple security levels, rapid and informed decisions can be made without sacrificing response time.

Additionally, military application includes military maintenance operators, which can obtain confidential information (technical drawings or repair & service manuals) both at the base, or near the frontline using SPCD. In addition, commercial operators can use SPCD to obtain personal or confidential information in non-secure public settings.

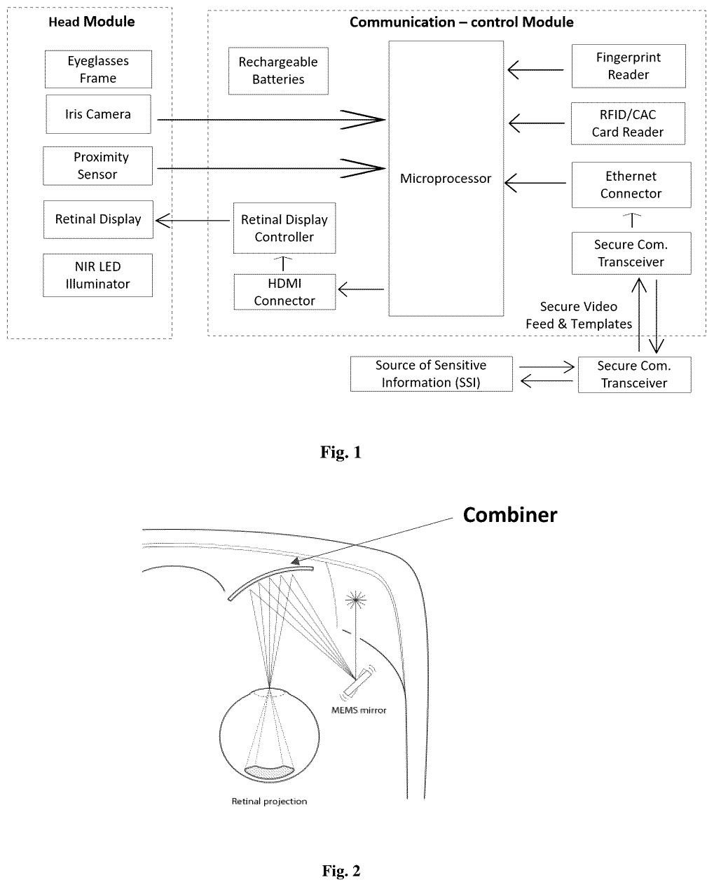

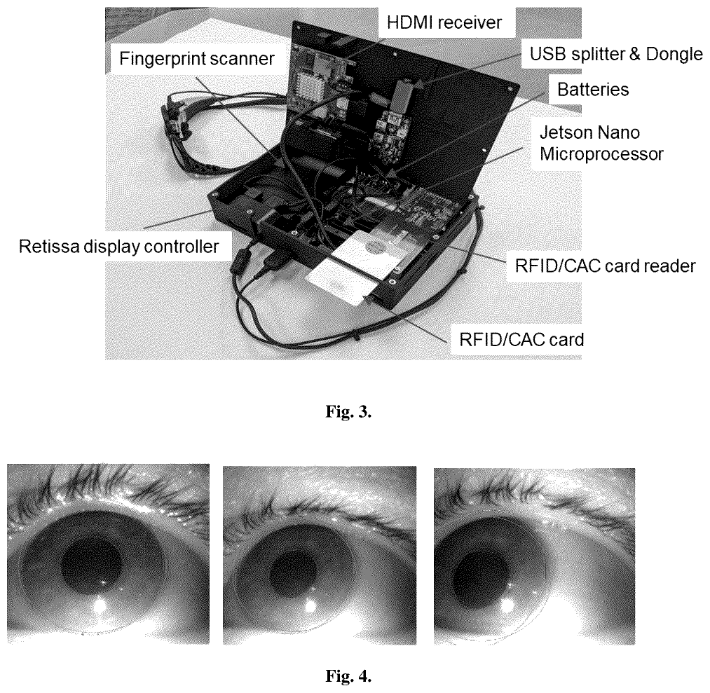

A prototype to demonstrate the SPCD concept was developed by the Applicants. The prototype included an iris imager, a fingerprint reader and RFID/CAC card as well as a proximity sensor to enable the display. A block diagram of a preferred embodiment of the present invention is illustrated in FIG. 1.

The computer performance, compact footprint, and flexibility of Jetson Nano microprocessor from Invidia Corporation will be useful to developers for creating artificial intelligence (AI) powered devices and embedded systems. A commercial platform can process up to eight high definition full-motion video streams in real-time and can be deployed as a low-power edge intelligent video analytics platform for Network Video Recorders (NVR) and smart cameras, and internet of things (IoT) gateways. As an example, Jetson Nano can detect an object on eight 1080p30 streams simultaneously with a detection model running at full resolution and a throughput of 500 megapixels per second (MP/s).

The concept is based on a combination of off-the-shelf hardware, and modifications to existing hardware and software. Applicants prefer the JETSON Nano microprocessor runs software to acquire iris images and fingerprint scans and compare them with the templates of authorized and enrolled users.

Much of the hardware for preferred embodiments is based on commercial-off-the-shelf (COTS) components. This hardware may include the off-the-shelf retinal scanning AR Retissa display described below. The iris camera system includes a miniature with NIR filter (Kodak Wratten Infrared filter (#87)) and near infrared (NIR) illuminator (Wurth Electronics 15427285BA240). Because standard iris cameras have large format and are located at distances of several meters from the iris, Applicants preferred embodiments include a miniature (3 mm×3 mm) camera (Omnivision OVM6211) located at the distance of less than 3 cm from the eye. The camera interface is a USB 3 interface to existing software to grab image frames and control the camera. The fingerprint scanner (Digital Persona U.are.U 4500) USB scanner compatible with the recognition software. The RFID/CAC card reader (SCM Microsystems SCR3310 v2) is DOD Military USB Common Access CAC Smart Card Reader.

The iris scanner and fingerprint reader feed images to off-the-shelf software (VeriEye and VeriFinger software packages from Neurotechnology) to make the comparison and perform positive identification of valid users. A Linux software development kit (SDK) permits integrating all operations.

The head module and communication-control waist module are connected by a fiber optics cable for data and display light transfer. No further processing or conversion of the light in the fiber optic cable takes place in the retinal scanner where light from the end of the fiber optic cable is delivered to the retina. The iris camera and LED illuminator are connected to the microprocessor in the waist module by a 36″ 14-wire MIPI cable with USB3 connector.

The principal off-the-shelf components of the SPCD are described below:

### The Retissa Display

Applicants' prototype uses a commercial Retissa retina display available from QD Laser Inc. located in Kawasaki, Kanagawa, Japan was selected for the SPCD for several reasons:
First, it is based on retinal scanning display technology, and an image is created directly on the retina.
Second, Retissa has a small eye-box and a built-in mechanism for adjusting the inter-pupillary distance (IPD). As a result, the Retissa display does not illuminate portions of the eye and face outside of the pupil of the eye. This dramatically reduces stray light and eliminates the possibility of visual eavesdropping. The “first pass” transmission in the Retissa display is eliminated by using an opaque blocker on the eyeglass lens. Due to the small eye-box and the opaque blocker on the lens of the eyeglasses; so there is no detectable light leakage outside of the display. This should eliminate the possibility of visual eavesdropping.
Third, Retissa is an augmented reality (AR) display and provides good local situational awareness via the user's other eye and more than 80 percent of the AR eye. Using the Retissa display, users can be mobile and freely work inside of an operation center or any other place where the user can communicate with the SSI. While mobile and able to view sensitive information, the wearer can also view his/her surroundings and has the capability to notice suspicious activity or behavior.
Fourth, Retissa provides spatial resolution that corresponds to the resolution of a subject with 20/20 vision. It has 1280×720 pixels (horizontal×vertical) with a 26° field of view and 1 arcmin pixel size. Retissa is nicely packaged, has the form factor of sunglasses, and supports covertness of operation.
Finally, the Retissa has adjustable parameters including inter pupillary distance (IPD) and distance from the eye. When display is adjusted for personal use, the user can comfortably see the displayed image even when he, or she, is moving or making sharp turns with a head.

### Eliminating the Potential for Optical Eavesdropping on the Retissa Display

Despite the fact that Retissa creates an image directly on the retina and does not illuminate portions of the eye and face outside of the pupil of the eye, as shipped from the manufacturer, there are two possibilities for light leakage outside of the display: a) first-pass transmission through the combiner mirror and b) scattered light retro-reflected from the retina back towards the MEMS mirror and leaked after multiple reflections either through the combiner or around the edges of the combiner. As shown in FIG. 2, light from the MEMS scanning mirror illuminates retina after reflection from the combiner mirror. Light that is not reflected or absorbed at the combiner is transmitted, and this transmission will be referred to as the first-pass transmission to distinguish it from the scattered light component. If detectable at adequate signal-to-noise ratio (SNR), the first-pass transmission through the combiner mirror could be used for optical eavesdropping. The scattered light component suffers attenuation with every scattering (from the retina, from the MEMS mirror, from the combiner mirror and visor) and disperses in solid angle. The human eye is a state-of-the-art detector, and the light incident on the retina is adequate for viewing. In the Retissa design, no extra light is added to create an expanded eye-box, so no extra light can be leaked outside of the display. Light reflected out of the eye is dramatically reduced in intensity and even without attenuation is no longer easy to decode. During subsequent scattering this light is attenuated by several orders of magnitude and is not detectable through the combiner mirror with usable signal-to-noise ratio (SNR). Note that Retissa components have the following transmission:
Visor: 0.217
Combiner mirror: 0.124
Visor+combiner mirror: 0.027

The implication is that the effective optical density (OD) of the visor plus combiner mirror together is OD 1.57. This is equivalent to 3.5% transmission. Reflection from the retina depends on wavelength, skin pigmentation and hair color. At 640 nm wavelength (visible light), retinal reflection varies from 3% for dark skin up to 10% for light skin, blond. For all skin and hair types, the reflection is below 4% in the green and blue.

Using the effective optical density (OD), one can estimate the first-pass light leak level. According to the Retissa specifications, power to eye is 0.39 μW. If maximum power to the retina is 0.39 μW and transmission of the combiner mirror+visor is 3.5%, then the first pass leak light level is 14 nW. This is a detectable light level. Solutions to reduce, or eliminate, the first pass transmission include:
1. Opaque blocker outside of the lens
2. Opaque blocker inside of the lens
3. Notch filter applied to the combiner mirror.

A low-cost solution for the first-pass transmission uses an opaque blocker inside, or outside, of the eyeglass lens. Applicants found that small blocker does affect the see-though view. Applicants also found that the opaque blocker inside of the eyeglasses lens is more covert and more secure because light reflected from the blocker is trapped inside of the display. This solution was selected. The blocker should eliminate the possibility of visual eavesdropping. A notch filter approach is also feasible and should allows for zero additional obscuration of the see-through view. However, the cost of the device will increase.

Applicants have compared Retissa augmented reality (AR) and Avegant Glyph virtual reality (VR) displays in three categories: situational awareness, covertness of operation, and visual eavesdropping. Applicants' AR display has several advantages in comparison with the Avegant Glyph VR Display. These advantages include:
Retissa AR display provides good local situational awareness while displaying sensitive or secret information, which allows the SPCD operation on the move.
Retissa AR display can duplicate the Avegant Glyph VR display capability by adding an opaque drop-down visor
Avegant Glyph VR display cannot duplicate the Retissa AR capability. Video relay requires active cameras, which are not allowed in a classified area.

At the same time, if operation on the move is not required for particular application, a VR display like Avegant Glyph AG101 VR Video Headsets available from Amazon can be used.

### Iris Camera System

Applicants preferred camera is an Omni Vision OV6211 available from OmniVision Technologies Inc. located in Santa Clara, CA, with the following specifications:
Active Array Size 400×400 pixels.
Bit depth: 8/10-bit RAW
3.2 mm³ package
FOV 50 deg diag.
F number 3.1
Integrated Lens Focal Len: 1.681 mm
Pixel Size 3 μm×3 μm
Sensitivity: 7190 mV/(micro watts/cm²/sec) @ 850 nm

The camera provides a USB 3 interface to the microprocessor which records iris images. The set of iris images processed using VeriEye software package written by Neurotechnology revealed that camera resolution meets the corresponding requirements for iris identification. In order to affix the iris camera, LED illuminator, and proximity sensor to the eyeglasses frame, custom enclosure and fixture was made using a 3D printer. A camera system comprising the iris camera, LED illuminator, proximity sensor, micro-USB connector, and enclosure is mounted on the eyeglasses frame.

### Iris Recognition Software

Applicants' team implemented and tested the commercially available iris recognition software package VeriEye available from NeuroTechnology Inc. located in Vilnuis, Lithuania. The camera was tested using publicly available data sets and by collecting iris images from multiple subjects.

Key features and capabilities of the VeriEye algorithm include:
Rapid and accurate iris identification.
Robust recognition, even with gazing-away eyes or narrowed eyelids.
A special algorithm solved the limitations and drawbacks of existing state-of-the-artalgorithms.
Available as a multiplatform software development kit (SDK) supporting multiple programming languages.

Applicants' prototype embodiment uses the VeriEye iris recognition software package. Iris recognition is an automated method of biometric identification that uses mathematical pattern-recognition techniques on images of one or both irises of an individual. The iris patterns are unique, stable, and can be seen from some distance. Iris recognition uses video cameras with invisible near-infrared (NIR) illumination to acquire images of detail-rich structures of the iris which are visible externally.

The iris is the ideal part of the human body for biometric identification for several reasons:
It is an internal organ and well protected against wear by highly transparent and sensitive membrane (the cornea). This distinguishes it from fingerprints, which can be difficult to recognize after years of certain types of manual labor.
The iris is mostly flat, and its geometric configuration is only controlled by two complementary muscles that control the diameter of the pupil. This makes the iris shape far more predictable than, for instance, that of the face.
The iris has a fine texture that is determined randomly during embryonic gestation. The chance of false matches for either iris or fingerprint is extremely low. Even genetically identical individuals, and the left and right eyes of the same individual have completely independent iris textures.

The government of India is enrolling the iris patterns of more than one billion residents for entitlements distribution run by the Unique Identification Authority of India (UIDAI). A key advantage of iris recognition, besides its speed of matching and its extreme resistance to false matches, is the stability of the iris as an internal and protected, yet externally visible organ of the eye.

The algorithm uses images of an iris while being illuminated by near-infrared (NIR) wavelengths (700-1000 nm) detectable by silicon-based imagers. The reason for this is that most people worldwide have dark brown eyes, the dominant phenotype of the human population, revealing less texture in the visible waveband but appearing richly structured in the NIR band. Second, using the NIR spectrum enables blocking of corneal specular reflections from external bright sources in the ambient environment, by allowing only those NIR wavelengths from the narrow-band illuminator back to the iris camera. Lastly, the NIR wavelengths have very low visibility to the human eye, so the process of bio-authentication does not interfere with normal vision.

As discussed in the Background Section, John Daugman developed the first algorithm to perform iris recognition and provided the first demonstrations of its use. In 1994 he patented a basis (U.S. Pat. No. 5,291,560 which is hereby incorporated herein by reference) for iris recognition and its underlying computer vision algorithms for image processing, feature extraction and matching. He subsequently published them in a paper. The three main stages of an iris recognition algorithm are image preprocessing, feature extraction and template matching. Since the inner and outer boundaries of an iris can be approximated as circles, a circular Hough transform is used to localize the iris. A Gaussian filter is applied to smooth the image to select the proper scale for edge analysis. A voting procedure is realized using the Hough transform to search for the desired contour from the edge map. At the feature extraction stage, texture analysis methods are used to extract the significant features from the normalized iris image. The extracted features are encoded to generate a biometric template. The biometric template is then compared with templates in the database to search for a match.

### Test Results of VeriEye Software Package Using a Miniature Iris Camera

A performance evaluation of the iris recognition algorithm was performed by Applicants using iris images recorded using a prototype of the present invention that has a block diagram shown in FIG. 1. The test was performed using iris images collected on 8 subjects. FIG. 4 shows samples of iris images recorded using miniature iris camera. The figure also shows pupil and iris boundaries detected by the VeriEye iris recognition software package. The analysis consists of comparison of the 18 enrolled images with all other images collected. In total 4,000 images for the 8 subjects were collected and processed. The results of Applicants testing have convinced the Applicants that they can be confident that the proposed iris camera and software can be relied upon to assure that the user of the SPCD can be identified from the iris images alone. However, if greater certainty is needed the SPCD package can be expanded to include the fingerprint imaging, the RFID card reader, and the proximity sensor.

### Secure Communication Transceiver

The GoSilent Cube available from Attila Security with offices located in Columbia, MD is a portable device that protects networks (such as the Internet) from malicious cyber activity while obfuscating the user's identity and location from. Unlike most other existing security solutions, GoSilent is flexible and can be deployed in the cloud, or premises or as a managed service. The GoSilent is simple, top secret level security for all communication from laptops, phones, and tablets to enterprise IoT devices, the GoSilent Cube easily protects any IP-enabled device. The transceiver uses Commercial National Security Algorithms (CNSA). Provides top secrete level crypto out of the box and a VPN throughput in in-line (ethernet to ethernet) mode is 90 Mbps.

At the SSI, the GoSilent Cube encrypts sensitive information using Commercial National Security Algorithms (CNSA) before sending information to the SPCD via Internet. At the receiving end, the GoSilent Cube in the SPD communication-control module decrypts received information and passes it to the retinal scanning display if a user has been positively identified.

Key features of the transceiver include:
Easy
   Zero-configuration, connects with IP-enabled devices; phones, tablets, pcs, IoT.
   Optimized user experience with a web admin console.
Portable
   At 2.6″×1.9″×1.2″, fits in your pack.
Power Usage
   Requires only 500 mW at 5V.
   Compatible with standard USB port or battery pack
Commercial National Security Algorithms (CNSA) Crypto
   Quantum Resistant
   Top Secret level crypto out of the box
   IKEv2 with certificates
   IKEv1 with pre-shared keys
   Commercial National Security Algorithms (CNSA)
Certifications
   NIAP certification 2 protection profiles
   Fire wall and VPN Gateway
   FIPS-140 Algorithm
Performance
   90 mbps of VIP throughput in in-line (ethernet-to-ethernet) mode
IP Obfuscation
   Invisible network traffic,
   Hides identity and location.

### Microprocessor

Jetson Nano processor available from Invidia Corporation located in Santa Clara, CA is a small, powerful computer for embedded applications and artificial intelligence (AI) Internet of Things (IoT) that delivers the power of modern AI in a $129 production-ready module.

Key features of Jetson Nano include:
GPU: 128-core NVIDIA Maxwell™ architecture-based GPU
CPU: Quad-core ARM® A57
Video: 4K @ 30 fps (H.264/H.265)/4K @ 60 fps (H.264/H.265) encode and decode
Camera: MIPI CSI-2 DPHY lanes, 12× (Module) and 1× (Developer Kit)
Memory: 4 GB 64-bit LPDDR4; 25.6 gigabytes/second
Connectivity: Gigabit Ethernet
OS Support: Linux for Tegra®
Module Size: 70 mm×45 mm.

### Fingerprint Reader

The DigitalPersona U.are.U 4500 is an optical USB 2.0 fingerprint reader from HID Global located in Austin, Texas that is able to reject latent or spoof fingerprints. The U.are.U 4500 HD model also features high durability sensor coating. It utilizes optical fingerprint scanning technology to achieve excellent image quality, a large capture area and superior reliability. A silicone coating allows it to read a wide range of fingerprints accurately and rapidly regardless of placement angle. Its compact design conserves desk space in enterprises, and its professional, modern appearance looks elegant in point-of-sale environments. It's easy to use—simply place a finger on the scanning window and the reader quickly and automatically captures and encrypts the fingerprint image before sending it to the DigitalPersona FingerJet biometric engine for verification. When a fingerprint image is successfully captured, the reader gives a red flash for user feedback. The U. are. U 4500 Fingerprint Reader is designed for use with a full range of Crossmatch software including their authentication solutions, as well as most of their Software Development Kits. The scanner is also certified as compliant to FBI Moblie FAP 30 standard. It is also available as fingerprint scanner module for OEM integration.

Key features of the finger reader include
Optical Fingerprint Scanning Technology
512 dpi Pixel Resolution
Excellent image quality
Fast image capture
Encrypted fingerprint data
USB 2.0 interface
Compatible with USB 1.0, 1.1, and 2.0
Blue LED
Small Form Factor (2.6″×1.6″×1.1″)
Image capture area: 0.8″×1.0″
8-Bit Grayscale Scan Data
Compatible with DigitalPersona Biometric SDKs
Silicone Coating
Works with Dry/Moist/Rough Fingerprints
Operating temperature: −10° C.-+50° C.

### Fingerprint Recognition Software

A fingerprint recognition software is a VeriFinger software package available from NeuroTechnology Inc. located in Vilius, Lithuania. Fingerprint recognition is the most popular and widely used biometric identification method. Fingerprints are unique and remain permanent throughout a person's life. Fingerprint identification has a great utility in forensic science and aids criminal investigations. Most of the automatic fingerprint recognition systems are based on local ridge features known as minutiae. Hence it is extremely important to mark these minutiae accurately and reject the false ones. However, fingerprint images are prone to degradation and corruption due to factors such as skin variations and impression conditions such as scares, dirt, humidity, and non-uniform contact with the scanning device. Thus, it is necessary to apply some type of image enhancement techniques before minutiae extraction. The most important step in automatic fingerprint matching is to reliably extract the minutiae from the captured fingerprint images. There exists a variety of techniques for extracting fingerprint minutiae.

A fingerprint is a distinct pattern of ridges and valleys on the finger surface of an individual. A ridge is defined to be a single curved segment whereas a valley is the area between two adjacent ridges. The dark areas of the fingerprint are called ridges and white areas that exists between them are known as valleys.

In a fingerprint identification system, the captured fingerprint image needs to be matched against the stored fingerprint templates of every user in the database. This involves a lot of computation and search overhead. A fingerprint classification system is needed, which will restrict the size of the templates database. To accomplish this, the minutiae features are extracted and matched against fingerprint template. The template size of minutiae-based fingerprint representation is small and most of the fingerprint identification systems are based on minutiae.

Minutiae points are major features of a fingerprint image and are used in the matching of fingerprints. These minutiae points are used to determine the uniqueness of a fingerprint image. A fingerprint image of a good quality can have 25 to 80 minutiae depending on the fingerprint scanner resolution and the placement of finger on the sensor.

Minutiae pattern recognition in the most widely used technique for fingerprint representation, and each configuration is highly distinctive. It is more accurately compared to other correlation-based systems, and the template size is smaller. In this system, two fingerprints match if their minutiae points match. The minutiae-based fingerprint technique is the backbone of most currently available fingerprint recognition products. Compared to other fingerprint features, the minutiae-point features having corresponding orientation maps are distinct enough to distinguish between fingerprints robustly. Fingerprint representation using minutiae features reduces the complex issue of fingerprint recognition to an issue of point pattern matching. Since the original image cannot be reconstructed using only the minutiae information, the minutiae-based fingerprint identification systems can assist privacy issues and minutiae are actually sufficient enough to prove finger individuality. In term of contrast, image resolution and global distortion, the minutiae are more sable and robust in relation to other fingerprint matching schemes. However, the primary challenge lies in extracting the minutiae from a poor-quality image. The quality of fingerprint images is directly linked to the performance of automatic fingerprint authentication systems.

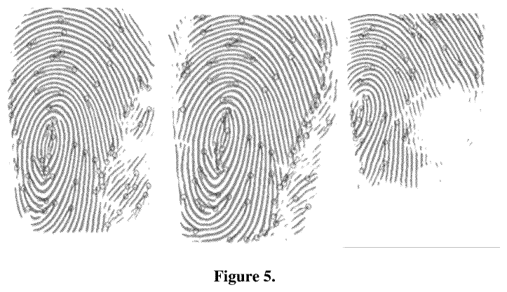

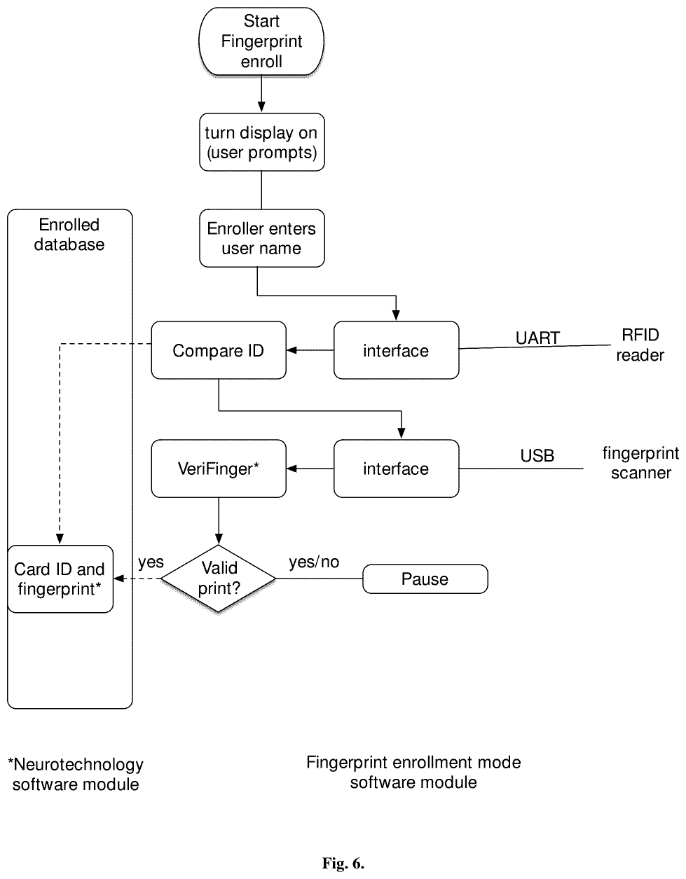

Applicants' team implemented and tested the commercially available VeriFinger software package from NeuroTechnology Inc. on publicly available data sets and by collecting fingerprint images from multiple subjects. Three fingerprint images recorded using DigitalPersona U.are.U 4500 fingerprint scanner and minutia determined by VeriFinger algorithm are shown in FIG. 5.

The VeriFinger algorithm is based on deep neural networks and follows the commonly accepted fingerprint identification scheme, which uses a set of specific fingerprint points (minutiae) along with a number of proprietary algorithmic solutions that enhance system performance and reliability. Some are listed below:
Rolled and flat fingerprints matching. The VeriFinger algorithm matches flat-to-rolled, flat-to-flat or rolled-to-rolled fingerprints with a high degree of reliability and accuracy, as it is tolerant to fingerprint deformations. Rolled fingerprints have much bigger deformation due to the specific scanning technique (rolling from nail to nail) than those scanned using the “flat” technique. Conventional “flat” fingerprint identification algorithms usually perform matching between flat and rolled fingerprints less reliably due to the mentioned deformations of rolled fingerprints.
Tolerance to fingerprint translation, rotation, and deformation. VeriFinger's proprietary fingerprint template matching algorithm is able to identify fingerprints even if they are rotated, translated, deformed and have only 5-7 similar minutiae (usually fingerprints of the same finger have 20-40 similar minutiae) and matches up to 40,000 flat fingerprints per second.
Identification capability. VeriFinger functions can be used in 1-to-1 matching (verification), as well as 1-to-many mode (identification).
Image quality determination. VeriFinger is able to ensure that only the best quality fingerprint template will be stored into database by using fingerprint image quality determination during enrollment.
Adaptive image filtration. This algorithm eliminates noises, ridge ruptures and stuck ridges for reliable minutiae extraction—even from poor quality fingerprints—with a processing time of 0.6 seconds.
Features generalization mode. This fingerprint enrollment mode generates the collection of generalized fingerprint features from a set of fingerprints of the same finger. Each fingerprint image is processed, and features are extracted. Then the features collection set is analyzed and combined into a single generalized features collection, which is written to the database. This way, the enrolled features are more reliable, and the fingerprint recognition quality considerably increases.
Compact fingerprint template. VeriFinger allows to configure the number and size of fingerprint features in a fingerprint template. Combined with unlimited database size, this capability allows optimization of target system size and performance
Scanner-specific algorithm optimizations. VeriFinger 11.2 includes algorithm modes that help to achieve better results for the supported fingerprint scanner.

The VeriFinger algorithm calculates a similarity measure. If the value of similarity measure exceeds a specified threshold, then two fingerprint images are deemed to match. If a similarity value is below the threshold, then the fingerprints are deemed to have not matched.

### Software for VeriFinger Algorithm

Similarly, the VeriFinger fingerprint recognition software has two modes: i) enrollment mode and ii) operational mode. This fingerprint enrollment mode generates a collection of generalized fingerprint features from a set of fingerprints of the same finger. Each fingerprint image is processed, and features are extracted. Then the features collection set is analyzed and combined into a single generalized features collection, which is written to the database. This way, the enrolled features are more reliable, and the fingerprint recognition quality considerably increases.
i) image quality determination,
ii) adaptive image filtration, and
iii) rolled and flat fingerprints matching.

Because the three-factor identification system includes i) an iris camera, ii) a fingerprint scanner, and iii) RFID/CAC card reader, the VeriEye and RFID/CAC card identification software packages are run continuously on an embedded processor. The VeriFinger software package runs on an embedded processor once at the start of operating mode.

### Proximity Sensor

A proximity sensor is a sensor able to detect the presence of nearby objects without any physical contact. The proximity sensor VL6180X from STMicroelectronics located in Coppell, Texas allows absolute distance to be measured independent of target reflection. Instead of estimating the distance by measuring the amount of light reflected back from the object (which is significantly influenced by color and surface), the VL6180X precisely measures the time the light takes to travel to the nearest object and reflect back to the sensor (Time-of-Flight). Combining an infrared emitter, a range sensor, and an ambient light sensor in a three-in-one ready-to-use reflowable package, the VL6180X is easy to integrate and saves the end-product maker long and costly optical and mechanical design optimizations. The module is designed for low power operation. Ranging and ambient light sensing measurements can be automatically performed at user defined intervals. Multiple threshold and interrupt schemes are supported to minimize host operations.

Main features of the sensor include:
Fast, accurate distance ranging
   Measures absolute range from 0 to 10 cm
   Independent of object reflectance
   Ambient light rejection
   Cross talk compensation for cover glass
Ambient light sensor
   High dynamic range
   Accurate/sensitive in ultra-low light
   Calibrated output value in lux
SWaP
   Size: 2.8 mm×4.8 mm×1 mm
   Weight: 0.9 g
   Power: 5 mW
Operating Temperature: minimum −20° C.; maximum +70° C.

The proximity sensor infrared emitter operates at 850 nm wavelength, or at the same wavelength as the NIR LED illuminator. Because the proximity sensor operates at the rate of 30 Hz, and iris camera takes exposures at the rate of 0.5 Hz, in order to avoid an interference between proximity sensor an NIR LED illuminator, the proximity sensor was turned off in the software during iris camera exposure.

### RFID/CAC Card Reader

The RFID/CAC card reader is MicroSD Card Reader from Adfruit Industries with offices located in New York City. This card reader is designed for ease of use. Onboard 5 v->3 v regulator provides 150 mA tor power-hungry cards. 3 v level shifting means you can use this with ease on either 3 v or 5 v systems. Uses a proper level shifting chip, not resistors: less problems, and faster read/write access. Use 3 or 4 digital pins to read and write 2 Gb+ of storage! Activity LED lights up when the SD card is being read or written. Max read speed is 16 MB/sec, max write speed is 6 MB/sec—most microSD cards are not this fast so the bottleneck will be the card, not the reader. Four #2 mounting holes. Push-push socket with card slightly over the edge of the PCB. So, it is easy to insert and remove a card. Operating Temperature—0° to 60° C./32° to 140° F. Storage temperatures—−40° to 85° C./−40° to 185° F. Comes with 0.1″ header (unattached) so you can get it on a breadboard or use wires—your choice. Tested and assembled at the Adafruit factory.

### NIR LED Illuminator

The NIR LED illuminator is 15427285BA240 LED from Wurth Electronik located in Niedernhall, Germany.

Key Features:
Type: Infrared (IR)
Current—DC Forward (Max): 1 A
Radiant Intensity: 160 mW/sr @ 1 A
Wavelength: 850 nm
Voltage: 1.8 V
Viewing angle: 120°
Operating temperatures: −40° C.-+85° C.

### An 850 nm Long-Pass Filter

An 850 nm long-pass filter is an 87 Kodak Wratten Infrared Filter available from Edmund Optics located in Barrington, NJ.

### SPCD Software Requirements & Software Flow

### Software Requirements for VeriEye Algorithm

The SPCD software has two modes: i) an enrollment mode, and ii) an operating mode. The enrollment mode permits valid users to be added to the templet databases by a “system administrator.” In the enrollment mode, the subject places the head module on his, or her, face and adjusts it so that the screen is fully visible (full 1024×600-pixel rectangle). At the same time the operator verifies that the iris is visible in the iris camera (live video is shown on the screen). Once the head module is aligned the operator hits a button to enroll the subject. The operator verifies the image is correctly processed. If the results are subjectively “good”, the subject is enrolled in the database. If the image is subjectively bad, the process is repeated until the subject can be enrolled.

In operating mode, the iris camera continuously acquires iris image frames, and then compares each iris image template to all enrolled templates.

### Software Flow for Three-Level Identification System

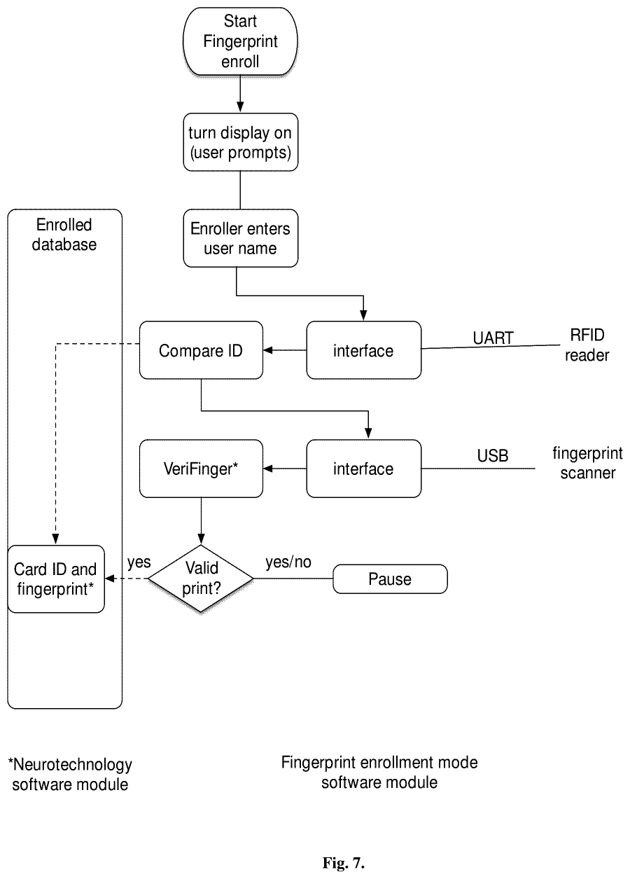

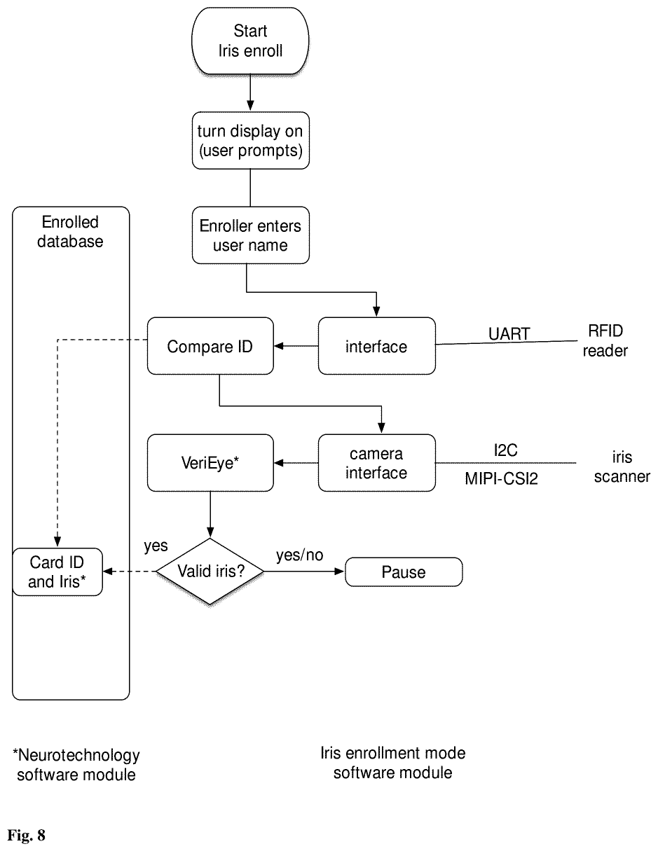

The software flow for the enrollment mode for fingerprint is shown in FIG. 7 and for iris in FIG. 8. In this mode the valid fingerprint and iris templates of the user are added to the corresponding databases via a console on a laptop. In addition, the user RFID/CAC card number is added directly to the fingerprint and iris databases using card reader vendor provided tools.

Enrollment mode is initiated over the network in a X-window console of an external laptop. The administrator then guides the user through the process of enrolling the fingerprint, iris, and RFID/CAC card into the valid user databases. In order to identify the valid user during fingerprint and iris scans in both enrollment and operating modes, the user RFID/CAC card must be placed in the card reader.

The fingerprint enrollment (FIG. 7) and iris enrollment (FIG. 8) have been separated into two different functions. The use of the same RFID/CAC card “connects” the user between the separate fingerprint and iris databases. At each step the administrator may visually inspect the image or data as a check on the image quality and validation. The captured image of the fingerprint and iris are displayed along with the pass/fail score for a valid image from the recognition software so the administrator can verify successful storage of a template. The head mounted display continuously shows instructions for the user. Such as to place the RFID/CAC card in the card reader, place finger on the fingerprint scanner, and place the display on head for proximity sensor validation and iris image capture. During iris scanning, a white screen will be provided on the display to enable the user to properly align the eye to the iris scanner using the Retissa mechanical Inter Pupillary Distance (IPD) adjuster.

The iris and fingerprint enrollment templet databases as well as RFID/CAC card numbers are created at an external laptop, and then transmitted and stored at the distant Source of Sensitive Information (SSI). In the operation mode, after a handshake between secure transceiver in the SPCD and transceiver at the SSI, the iris and fingerprint enrollment databases are transmitted from the SSI to SPCD for iris, fingerprint, and RFID/CAC card identification. Because enrollment templet databases are stored at the SSI, not at the SPCD, then this information cannot be compromised when SPCD is lost or stolen.

The software flow in the operating mode is shown in FIG. 9. First, the RFID/CAC card number is read and compared with that in enrollment database. Then, the fingerprint is scanned. Once a valid fingerprint match is found and RFID/CAC card is positively identified, a head module is placed on the user's head, and the iris images are recorded. When a head module is on the user head, the proximity sensor pointed at the one wearer eye is continuously checked at about 10 Hz. At the same time, the iris camera and RFID/CAC card reader are checked continuously at about 0.5 Hz. The authentication of the iris is performed on the same eye to which sensitive information will be displayed.

If the iris is positively identified and RFID/CAC card, fingerprint, and proximity sensor are valid, the software connects the retinal scanner controller to the secure communication link transceiver in the communication-control module connected via secure communication link to the Source of Sensitive Information (SSI). Various types of sensitive information including text, technical drawings, manuals, maps, and videos can be displayed in full color.

A positively identified enrolled individual may view sensitive information until one of three things happens: i) The RFID/CAC card is removed from the card reader and/or replaced with an invalid card, ii) iris fails to match the user template, or iii) the proximity sensor indicated that the head module has been removed from the wearer's head. In any of the three cases, the iris retinal scanning display is shut off.

After failure, all four identification modes, RFID/CAC card, fingerprint, iris, and proximity sensor must be valid again to restore the secure display. Prior to user validation or after failure, the display instructions on user action required to restore the secure display are shown. Such as insert RFID/CAC card, place finger on fingerprint scanner, place head module on head, etc. Finally, the proximity sensor shutoff is implemented in hardware to provide secure display shutoff in less than 0.2 second in the case that the head module is removed from the user's head. The retinal scanner remains shutoff by the proximity sensor until there is a software reset produced by valid RFID/CAC card, fingerprint, and iris identification. The SPCD will automatically enter the operating mode on power-up. Because enrollment databases are stored at the distant SSI, not locally, sensitive information about iris, fingerprint, and RFID/CAC card of the authorized individual is safe in case when the SPDC is lost, or stolen.

### VARIATIONS

Applicants have described in detail preferred embodiment of the present invention. Persons skilled in the present art will recognize that many changes and additions could be made without departing from the basic concepts of the present invention. For example, iris imaging and retinal scanning techniques could be combined with techniques other than fingerprint readers and RFID/CAC card readers and proximity sensor to assure tin identity of the wearer of the SPCD. A VR display can be used in the applications when situation awareness is not required. The iris and fingerprint templates of authorized individuals can be stored at the distant SSI as described above or if desired, at other locations. Therefore, the scope of the present invention should be based on the appended claims and their equivalence and not from the specific descriptions provided above.

What is claimed is:

1. A secure personal communication device (SPCD) for providing secure communication between a user of the SPCD and a source of secure information (SSI) via a retinal scan of an eye of the user prior to and during transmission of the sensitive information to the user, said SPCD comprising:
A) a head mounted module comprising
1) an eyeglasses frame,
2) a miniature iris camera system mounted on the eyeglasses frame, said camera system comprising:
a. an infrared laser diode adapted to illuminate an iris of one eye of the user,
b. a miniature camera adapted to collect iris image data from one iris of the user,
3) a retinal scanning display system comprising a set of red, green, and blue eye-safe lasers, and a MEMS mirror mounted on the eyeglasses frame wherein the scanning display system is adapted to scan sets of laser beams from the eye safe lasers on a retina of the one eye of the user to present to the user, video images conveying the sensitive information.
B) a communication-control module comprising a radio transceiver and a microprocessor wherein:
1) the microprocessor is adapted to compare collected iris image data to pre-recorded iris image data to confirm or deny the correct identity of the user,
2) the radio transceiver is a secure radio transceiver adapted to transmit communications to and from the distant SSI, notification confirming or denying correct iris identification of the user and to receive sensitive information from the SSI in the form of radio communication,
3) the microprocessor is adapted to connect retinal display controller to the secure communication link transceiver to convert the sensitive information, received from the distant SSI, into image information viewable by the user,

2. The SPCD as in claim 1 wherein the secure communication control module is mounted on the user's waist.

3. The SPCD as in claim 1 wherein the miniature camera includes an 850 nm long-pass filter.

4. The SPCD as in claim 2, said SPCD further comprising a fingerprint recognition digital devise adapted to:
A) monitor at least one fingerprint of the user prior to each separate transfer of sensitive information to the user, wherein said fingerprint recognition device is adapted to utilize optical fingerprint scanning technology, and to
B) transmit fingerprint images to the microprocessor for verification by comparing a fingerprint image of the user with pre-recorded information contained in a pre-recorded fingerprint database so as to provide additional certainty to the SSI that the identity of the user is who he should be.

5. The SPCD as in claim 4, said SPCD further comprising a RFID/CAC card reader adapted to compare a RFID/CAC card possessed by the user with prerecorded information contained in a database so as to provide additional certainty to the SSI that the identity of the user is who he should be

6. The SPCD as in claim 5, wherein said SPCD further comprising a proximity sensor mounted on the eyeglasses frame and programmed to prevent communication from the distant SSI to the SPCD in less than 0.1 second if the iris camera is more than 3 centimeters from the user's eye.

7. The SPCD as in claim 1 wherein the retinal scanning display is a modified version of an Augmented Reality (AR) Retissa display with an opaque blocker on the inside of the lens to block the first pass transmission through the combiner mirror to minimize potential of visual eavesdropping.

8. The SPCD as in claim 1 wherein the retinal scanning display is a modified version of an AR Retissa display with an opaque blocker on the outside of the lens to block first pass transmission through the combiner mirror to minimize probability of visual eavesdropping.

9. The SPCD as in claim 1 wherein the retinal scanning display is a modified version of an Retissa display with a notch filter applied to the combiner mirror to block first pass transmission through the combiner mirror to minimize probability of visual eavesdropping.

10. The SPCD as in claim 1 wherein the iris camera is miniature Omnivision OVM6211 camera.

11) The SPCD as in claim 5 wherein the proximity sensor is VL6180X proximity sensor from STMicroelectronics.

12. The SPCD as in claim 1 wherein the secure communication transceiver is a GoSilent Cube from Attila Security.

13. The SPCD as in claim 1 wherein the microprocessor is a Jetson Nano embedded processor.

14. The SPCD as in claim 1 wherein the fingerprint reader is U.are.U 4500 fingerprint reader supplied by DigitalPersona.

15. The SPCD as in claim 4 wherein the RFID/CAC card reader is MicroSD Card Reader from Adfruit Industries.

16. The SPCD as in claim 1 wherein enrollment data base with iris and fingerprint templets and RFID/CAC card numbers of the authorized and enrolled individuals are stored at the distant SSI and transmitted to SPCD after a headshake between secure communication transceiver of the SPCD and secure communication transceiver of the SSI to prevent a loss of this information when the SPCD is lost, or stolen.
